(19) United States
(12) Patent Application Publication
(10) Pub. No.: US 2025/0110362 A1
(43) Pub. Date: Apr. 3, 2025

(54) INTEGRATED OPTICAL PHASE SHIFTER USING BURIED ELECTRODES

(71) Applicant: Government of the United States of America, as represented by the Secretary of Commerce, Gaithersburg, MD (US)

(72) Inventors: Daron Alexander Westly, Rockville, MD (US); Gregory Thomas Moille, Washington, DC (US); Kartik Arvind Srinivasan, Rockville, MD (US)

(21) Appl. No.: 18/902,229

(22) Filed: Sep. 30, 2024

Related U.S. Application Data
(60) Provisional application No. 63/586,818, filed on Sep. 29, 2023.

(51) Int. Cl. G02F 1/035; G02F 1/03

(52) U.S. Cl. CPC G02F 1/035; G02F 1/0316; G02F 2203/50

(57) ABSTRACT

Exemplary embodiments include buried electrodes that allow for bottom electrode integration with photonic devices, while retaining the ability to perform the high-temperature processing steps used in low-loss photonic elements. In addition to functionality in the case of buried heaters for thermal tuning of devices, the same or similar techniques can be applied to other tuning mechanisms, based on the electro-optical effect and (piezoelectrically-mediated) stress-optical effect.

### RELATED APPLICATIONS

This application claims the benefit of U.S. Provisional Patent Application Ser. No. 63/586,818 (filed Sep. 29, 2023), which is herein incorporated by reference in its entirety.

### FEDERALLY-SPONSORED RESEARCH AND DEVELOPMENT

This invention was made with United States Government support from the National Institute of Standards and Technology (NIST), an agency of the United States Department of Commerce. The Government has certain rights in this invention.

### FIELD OF INVENTION

The present invention relates generally to integrated photonics, and more particularly to the tuning of integrated photonics resonators, waveguides, and related structures such as interferometers and delay lines using the thermo-optical, electro-optical, and/or stress-optical effects.

### SUMMARY OF INVENTION

In-situ control of the effective refractive index of waveguide modes is a core requirement for many applications involving integrated photonics. This control of the effective refractive index enables, for example, wavelength tuning of the modes of integrated photonics resonators and control of the interference signal from optical interferometers. The effective refractive index can be tuned by tuning the refractive index of the constituent waveguide materials. Conventional approaches to tuning the refractive index of the materials involve metallic electrodes, which are used to apply heat or an electric field or actuate strain, all of which change refractive index. The precise location(s) of the electrodes relative to the waveguide layer is important—they need to be close enough to the waveguide layer to be effective, but far enough way to avoid the introduction of optical loss, which can happen when the optical field impinges on the electrodes (because metals are absorbing at optical wavelengths).

In many cases, it is straightforward to place electrodes on either side of an optical waveguide. It can also be straightforward to place electrodes above an optical waveguide in cases where the waveguide core is embedded in a thick enough dielectric cladding (usually a few micrometers) that the metal layer can be placed above the cladding without introducing optical loss, but still close enough to be effective.

For side electrodes, it is hard to arbitrarily route the metallic traces that lead from the electrodes to the contact regions, because you have photonic devices in-between and the metal needs to avoid them. For buried electrodes, there is no such restriction in the metallic trace routing. This is the same for electrodes that sit on top of a cladding layer but was previously not available to air-clad devices.

However, it tends to be more challenging to place electrodes underneath the waveguiding layer. This is because certain fabrication steps needed for processing the waveguide and cladding layers (such as annealing to reduce optical absorption) are usually incompatible with metals (e.g., temperatures are too high for metals). For top and side electrodes, the waveguide processing comes before processing the metal layer(s), so the metals are never subjected to high temperatures. However, for electrodes underneath the waveguiding layer, the waveguide processing comes after processing the metal layer(s), so the metals can be subjected to high temperatures.

However, there are several important reasons why underlying (buried) electrodes are useful. One set of circumstances is when the waveguide's top cladding must be air, e.g., for dispersion engineering purposes (to engineer nonlinear interactions occurring at short wavelengths) or for interaction with gas- or liquid-phase atoms, molecules, or other related systems, all while retaining high optical quality factors/low waveguide losses. In such situations, a top electrode isn't possible, and side electrodes can be inefficient, due to indirect thermal paths (in the case of heaters) or inability to take advantage of a materials' dominant electro-optic or piezo-electric coefficients (in the case of electro-optic and strain tuning devices).

Exemplary embodiments including buried electrodes allow for bottom electrode integration with photonic devices, while retaining the ability to perform the high-temperature processing steps used in low-loss photonic elements. In addition to functionality in the case of buried heaters for thermal tuning of devices described most frequently herein, the same or similar techniques can be applied to other tuning mechanisms, based on the electro-optical effect and (piezoelectrically-mediated) stress-optical effect.

### BRIEF DESCRIPTION OF THE DRAWINGS

FIG. 1 shows a schematic layer diagram of an exemplary thermo-optic phase shifter.

FIG. 2 shows a step of an exemplary process for creating an exemplary thermo-electric phase shifter.

FIG. 3 shows a step of an exemplary process for creating an exemplary thermo-electric phase shifter.

FIG. 4 shows a step of an exemplary process for creating an exemplary thermo-electric phase shifter.

FIG. 5 shows a step of an exemplary process for creating an exemplary thermo-electric phase shifter.

FIG. 6 shows a step of an exemplary process for creating an exemplary thermo-electric phase shifter.

FIG. 7 shows a step of an exemplary process for creating an exemplary thermo-electric phase shifter.

FIG. 8 shows a step of an exemplary process for creating an exemplary thermo-electric phase shifter.

FIG. 9 shows a step of an exemplary process for creating an exemplary thermo-electric phase shifter.

FIG. 10 shows a step of an exemplary process for creating an exemplary thermo-electric phase shifter.

FIG. 11 shows a step of an exemplary process for creating an exemplary thermo-electric phase shifter.

FIG. 12 shows a step of an exemplary process for creating an exemplary thermo-electric phase shifter.

FIG. 13 shows a step of an exemplary process for creating an exemplary thermo-electric phase shifter.

FIG. 14 shows a flow diagram of an exemplary process for creating an exemplary thermo-electric phase shifter.

FIG. 15 shows a schematic layer diagram of an exemplary electro-optic phase shifter.

FIG. 16 shows a step of an exemplary process for creating an exemplary electro-optic phase shifter.

FIG. 17 shows a step of an exemplary process for creating an exemplary electro-optic phase shifter.

FIG. 18 shows a step of an exemplary process for creating an exemplary electro-optic phase shifter.

FIG. 19 shows a step of an exemplary process for creating an exemplary electro-optic phase shifter.

FIG. 20 shows a step of an exemplary process for creating an exemplary electro-optic phase shifter.

FIG. 21 shows a step of an exemplary process for creating an exemplary electro-optic phase shifter.

FIG. 22 shows a step of an exemplary process for creating an exemplary electro-optic phase shifter.

FIG. 23 shows a step of an exemplary process for creating an exemplary electro-optic phase shifter.

FIG. 24 shows a step of an exemplary process for creating an exemplary electro-optic phase shifter.

FIG. 25 shows a step of an exemplary process for creating an exemplary electro-optic phase shifter.

FIG. 26 shows a step of an exemplary process for creating an exemplary electro-optic phase shifter.

FIG. 27 shows a step of an exemplary process for creating an exemplary electro-optic phase shifter.

FIG. 28 shows a step of an exemplary process for creating an exemplary electro-optic phase shifter.

FIG. 29 shows a step of an exemplary process for creating an exemplary electro-optic phase shifter.

FIG. 30 shows a step of an exemplary process for creating an exemplary electro-optic phase shifter.

FIG. 31 shows a step of an exemplary process for creating an exemplary electro-optic phase shifter.

FIG. 32 shows a flow diagram of an exemplary process for creating an exemplary electro-optic phase shifter.

FIG. 33 shows a schematic layer diagram of an exemplary stress-optic phase shifter.

FIG. 34 shows an optical microscope image of a fabricated chip consisting of WG-coupled microring resonators with the underlying buried heaters.

### DETAILED DESCRIPTION

Thermo-optic phase shifters in integrated photonics are typically realized through metal heaters (other materials, such as doped polysilicon, could also work), in which an applied current causes a change in temperature to the materials in thermal contact with the metal. As metals are strongly absorbing at optical wavelengths, in integrated photonic devices they cannot be placed in direct contact with waveguides (WGs), but instead must be separated from them, typically by a few hundred nanometers to a few micrometers, depending on the wavelength and the amount of absorption that can be tolerated. Conventional approaches for incorporating metal heaters in air-clad integrated photonics devices place the heater to the side of the waveguide. In contrast, exemplary embodiments of the present invention place the heater underneath the waveguide. This ‘buried heater’ placement is far more efficient: for the same electrical power applied to the heater, with exemplary resonators experiencing a nearly 5 times larger frequency shift (this corresponds to a nearly five times larger change in temperature). The optical phase change (Δϕ) per unit length of the WG (L) is given by:

$$\frac{Δϕ}{L} = 2 π ( \frac{dn}{dT} Δ T ) / λ$$

In this equation, dn/dT is the change in WG effective refractive index with respect to temperature and depends on the constituent materials, waveguide dimensions, and wavelength, ΔT is the change in temperature, and λ is the wavelength of light. The phase change per unit length is thus directly proportional to the change in WG temperature.

Further characterization of exemplary embodiments can be found in Moille, G. et al. Integrated buried heaters for efficient spectral control of air-clad microresonator frequency combs. APL Photon. 7, 126104 (2022), the contents of which are hereby incorporated herein by reference in their entirety.

To realize the buried heaters in practice, exemplary processes will be discussed further below, but key steps include the ability to deposit SiO₂ above the metal heater layer using a low temperature plasma process, the planarization of the SiO₂ layer through chemical-mechanical polishing, and the ability to grow a high quality WG layer such as SiN created by low pressure chemical vapor deposition (LPCVD). In particular, the LPCVD growth temperature is much higher than what one would typically subject a metal layer to, but because the metal is encapsulated in high-quality SiO₂ on all sides, its diffusion is minimal. Moreover, even higher temperature annealing steps, needed for reduction of optical absorption losses in the SiO₂ and SiN layers, are also compatible. We also note that while metal may be used for the heater layer in exemplary embodiments, other materials, such as polysilicon, could be substituted in other exemplary embodiments.

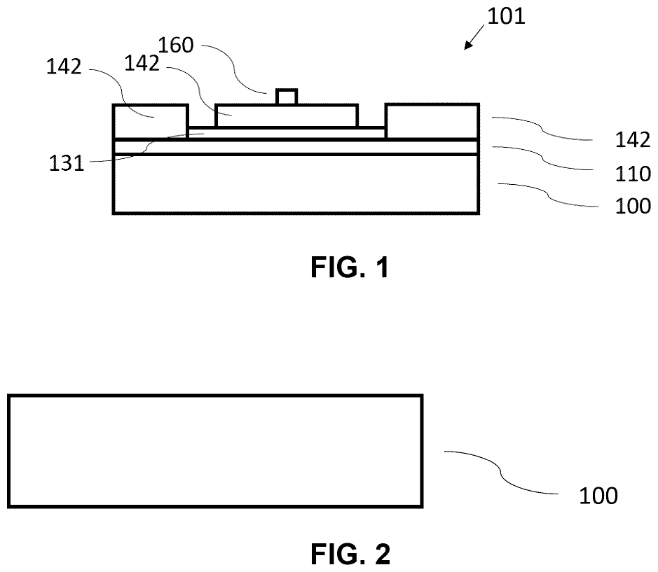

Referring first to FIG. 1, an exemplary thermo-optic phase shifter 101 includes a substrate 100, insulating layer 110, buried electrode 131, lower cladding 142, and waveguide layer 160. The buried electrode 131 is a metallic resistive heater element (preferably a thin metal or combination of metals, such as 100 nm of Cr/Pt). When the electrode is contacted from above (through an opening in the lower cladding layer 142) and current injected into the electrode, it causes an increase in temperature for lower cladding layer 142 and waveguide layer 160. This increase in temperature changes the refractive indices of these two layers, which is used for tuning purposes.

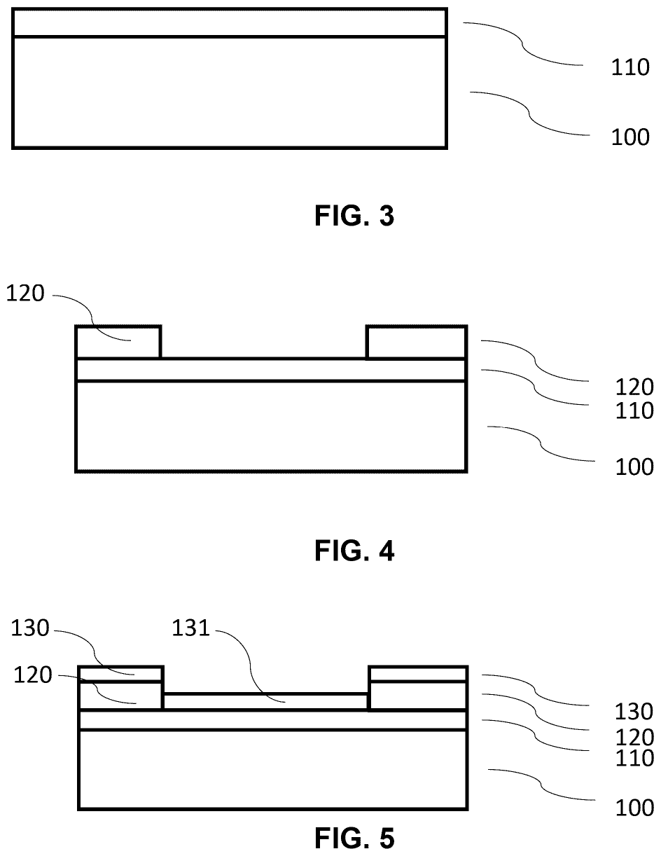

Referring now to FIGS. 2-14, a process 200 for creating an exemplary thermo-electric phase shifter 101 is shown.

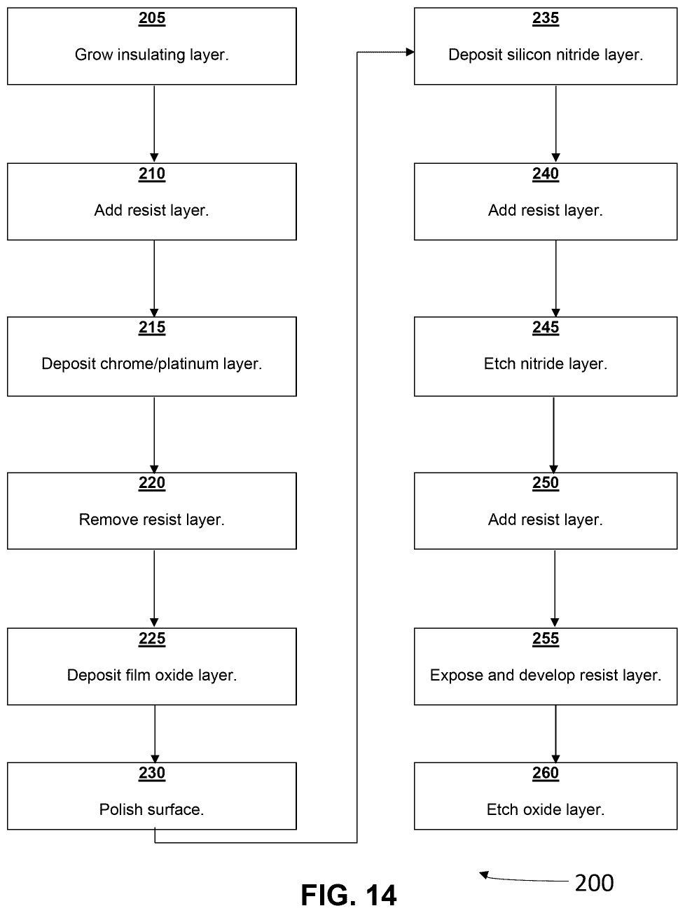

In FIG. 14, at block 205 an insulating layer of silicon dioxide produced by thermal oxidation (thermal oxide) 110 is grown on a silicon substrate 100. This layer 110 could also be added in other ways known in the art, such as, for example, a deposited oxide such as from plasma enhanced chemical vapor deposition (PECVD), low temperature oxide (LTO), high temperature oxide (HTO), or other chemical or physical deposition technique.

At block 210, the assembly 103 is spun and exposed to develop a resist layer 120, shown in FIG. 4, thereon. The resist layer 120 may be used as a sacrificial liftoff layer. This layer may be exposed in either an optical lithography or ebeam lithography system, for example.

At block 215, a chrome/platinum layer 130, 131 is deposited using electron beam evaporation or physical sputtering, as shown in FIG. 5.

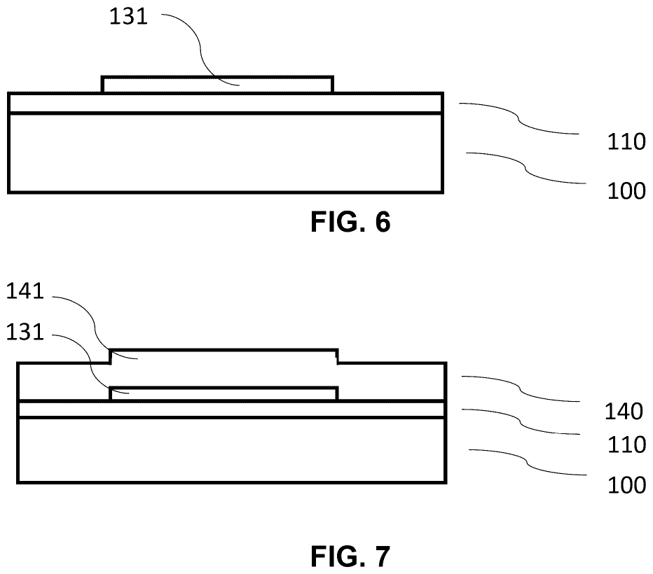

At block 220, the sacrificial resist layer 120 is removed along with the chrome/platinum layer 130 on top of the sacrificial layer 120 by soaking in solvent, leaving only the chrome/platinum layer 131 directly on top of the oxide 110, as shown in FIG. 6.

At block 225, a film oxide layer 140 is deposited using PECVD, LTO, or other physical or chemical deposition technique and annealed (for example, and without limitation, at 1000° C. for three hours) to densify the film oxide layer 140. The deposition will leave a bump 141 in the oxide layer over the platinum, as shown in FIG. 7, that may be removed in a subsequent step.

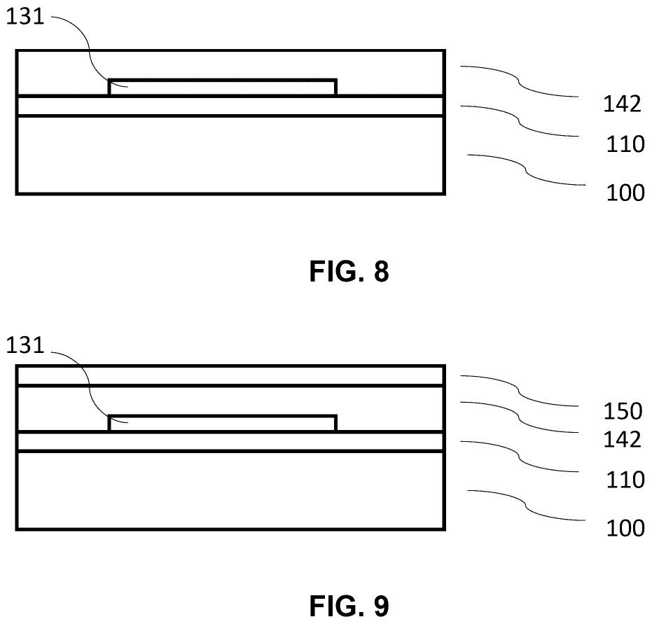

At block 230, chemical mechanical polishing (CMP) may be used to polish the surface and leave a smooth, planar film 142, as shown in FIG. 8.

At block 235 and as shown in FIG. 9, a layer of stoichiometric silicon nitride 150 may be deposited on the smoothed planar film 142.

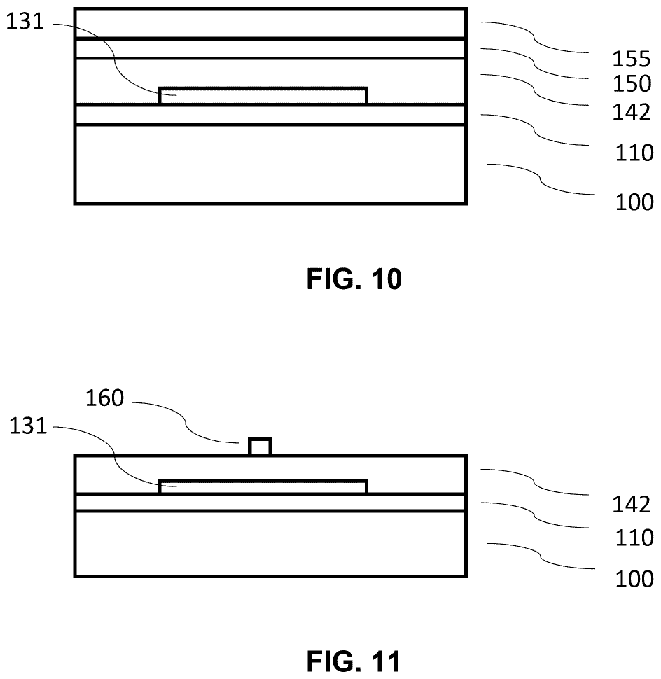

Next, at block 240, a layer of resist 155 may be spun to act as an etch mask for the nitride, as shown in FIG. 10. This layer of resist 155 can be either ebeam resist or photoresist and can be either positive or negative tone, depending on the pattern.

Next, at block 245, the resist 155 may be exposed and developed, and the nitride layer 150 may be etched using reactive ion etching (RIE) or other etch technique to leave behind the patterned nitride 160, as shown in FIG. 11.

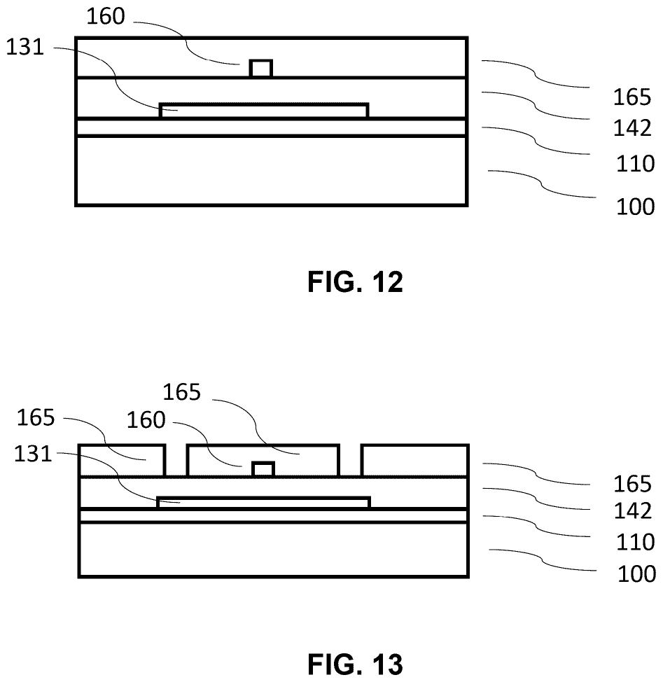

Next, at block 250, a resist layer 165 may be spun, as shown in FIG. 12.

Then, at block 255, the resist 165 may be exposed and developed in such a manner as to result in openings to the oxide layer 142, as shown in FIG. 13, using processes known in the art.

Finally, at block 260, the oxide 142 may be etched down to the platinum layer 131 using RIE or buffered oxide etch (BOE) and remainder of resist 165 may be removed with solvent, resulting in the structure shown in FIG. 1. The opening may be used to make electrical contact to the underlying platinum layer 131.

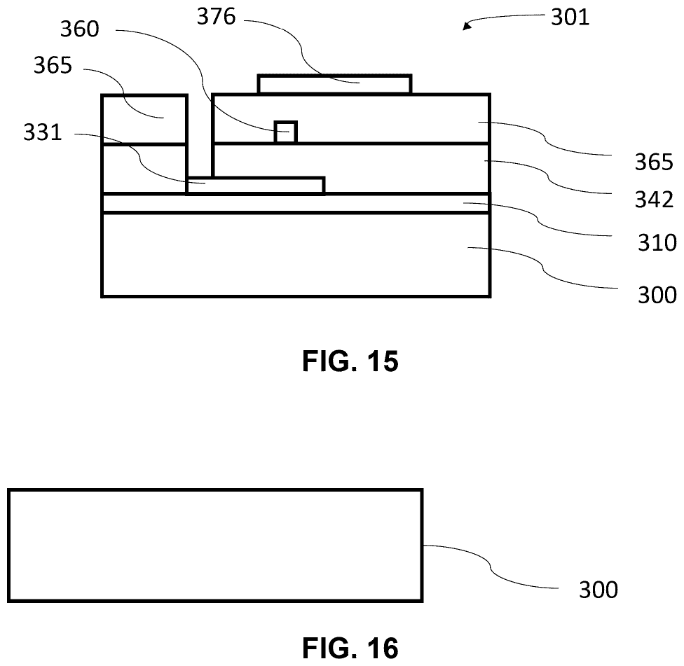

Referring now to FIG. 15, an exemplary electro-optic phase shifter 301 is shown. The phase shifter 301 includes a substrate 300, an insulating layer 310, a buried electrode 331, lower cladding 342, a waveguide layer 360, upper cladding layer 365, and a top electrode 376.

An electric field may be generated between the buried electrode layer 331 and the top electrode layer 376. This vertically-oriented field provides maximal effect for a waveguide layer 360 whose electro-optic coefficients are maximal for a vertically-oriented electric field (z-axis direction shown in the image). The amplitude of the z-oriented field, for a given voltage, is larger using a buried electrode than it would be for side electrodes.

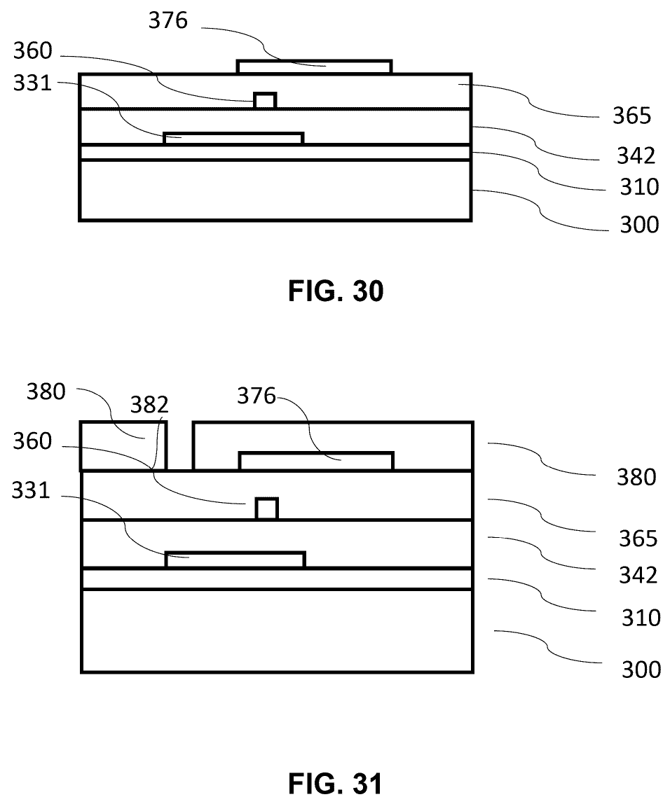

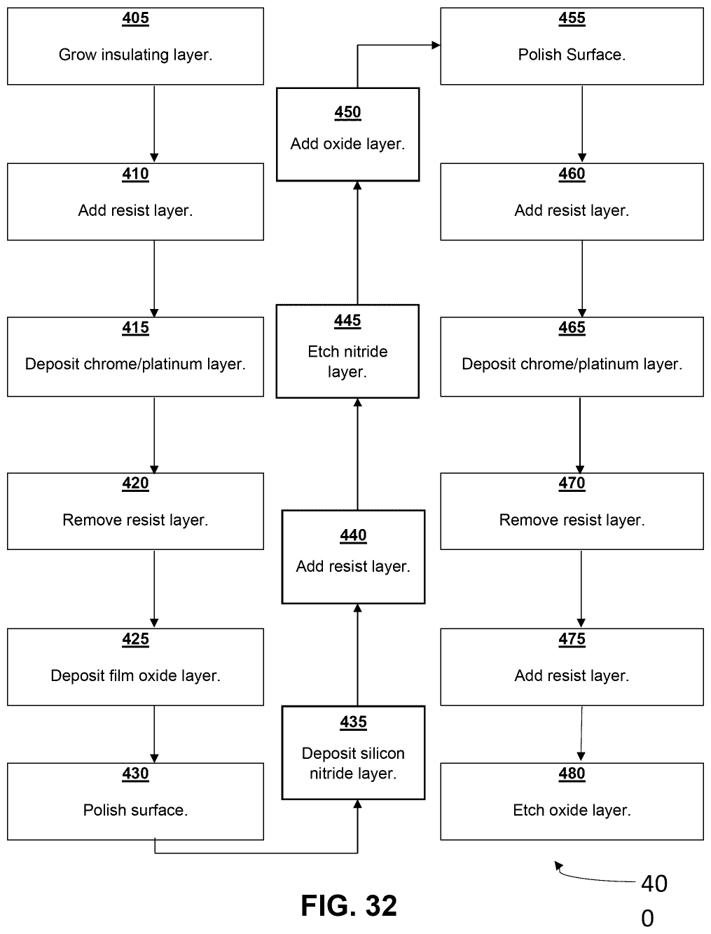

Referring now to FIGS. 16-32, an exemplary electro-optic phase shifter 301 may be created by the process 400 illustrated in FIG. 30.

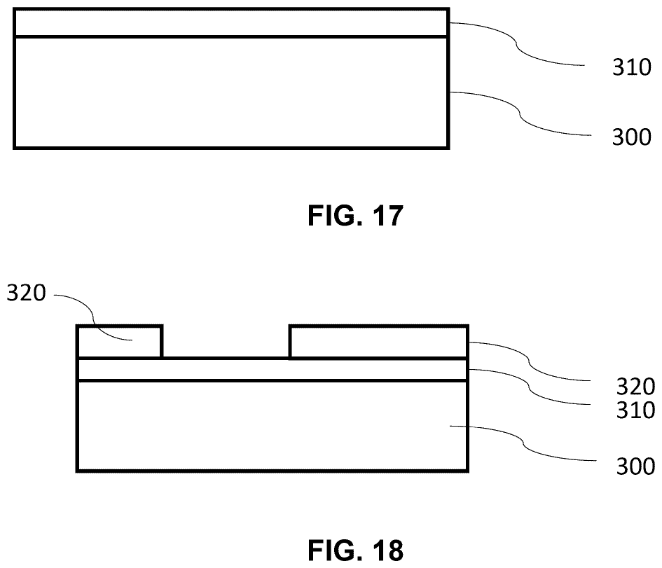

At block 405, an insulating layer of thermal oxide 310 is grown on a silicon substrate, as shown in FIGS. 16-17. This layer 310 may also be a deposited oxide such as from plasma enhanced chemical vapor deposition (PECVD), low temperature oxide (LTO), high temperature oxide (HTO), or other chemical or physical deposition techniques.

At block 410, a resist layer 320 may be spun, exposed, and developed, as shown in FIG. 18. This layer 320 may be used as a sacrificial liftoff layer. This layer 320 may be exposed in either an optical lithography or ebeam lithography system, for example.

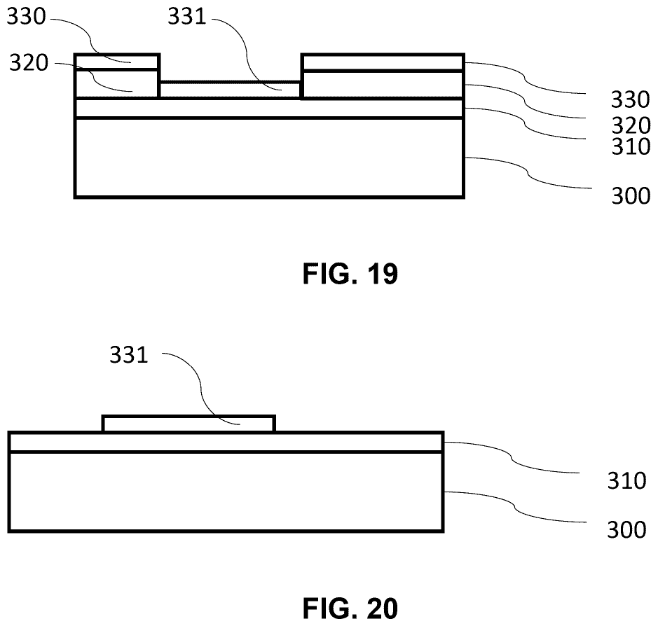

At block 415, a chrome/platinum layer 330, 331 may be deposited using, for example, electron beam evaporation or physical sputtering, as shown in FIG. 19.

At block 420, the sacrificial resist layer 320 may be removed along with the chrome/platinum layer 330 on top of the sacrificial layer 320 by soaking in solvent, leaving only the chrome/platinum layer 331 directly on top of the oxide 310, as shown in FIG. 20.

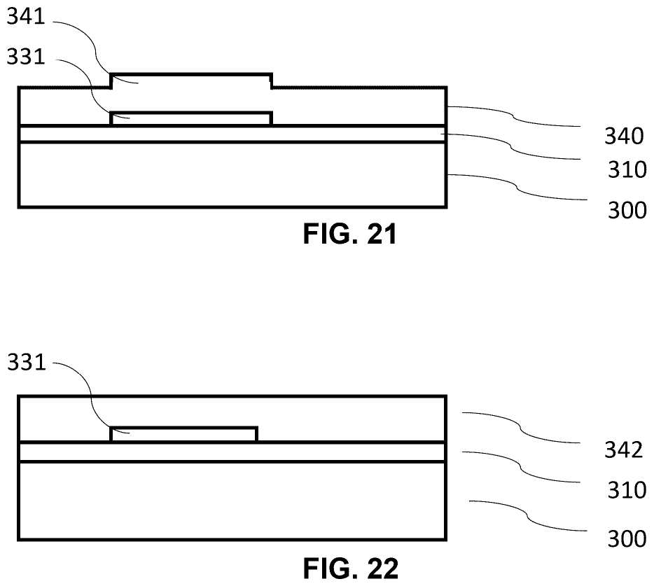

At block 425, an oxide layer 340 may be deposited using PECVD, LTO, or other physical or chemical deposition techniques and annealed (for example, and without limitation, at 1000° C. for three hours) to densify the film 340. The deposition will leave a bump 341 in the oxide layer over the platinum, as shown in FIG. 21, that may be planarized in a subsequent step.

At block 430, chemical mechanical polishing (CMP) or another technique may be used to polish the surface and leave a smooth, planar film 342, as shown in FIG. 22.

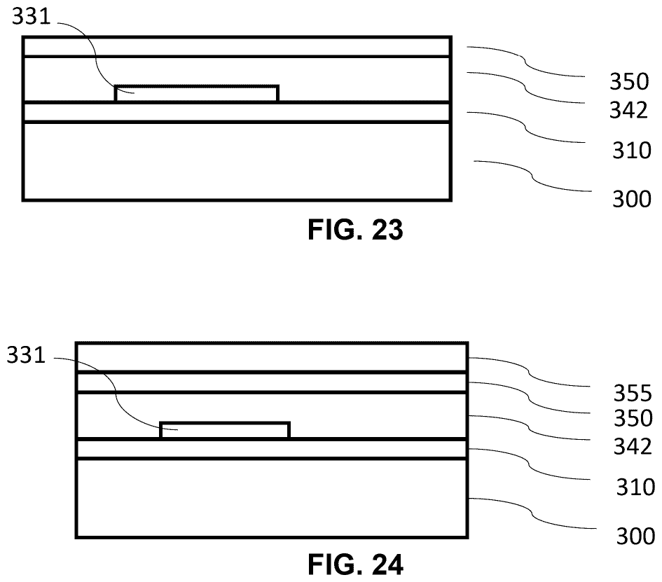

At block 435, a layer of stoichiometric silicon nitride 350 may be deposited as shown in FIG. 23.

At block 440, a layer of resist 355 may be spun to act as an etch mask for the nitride as shown in FIG. 24. This layer 355 can be either ebeam resist or photoresist, for example, and can be either positive or negative tone, depending on the pattern.

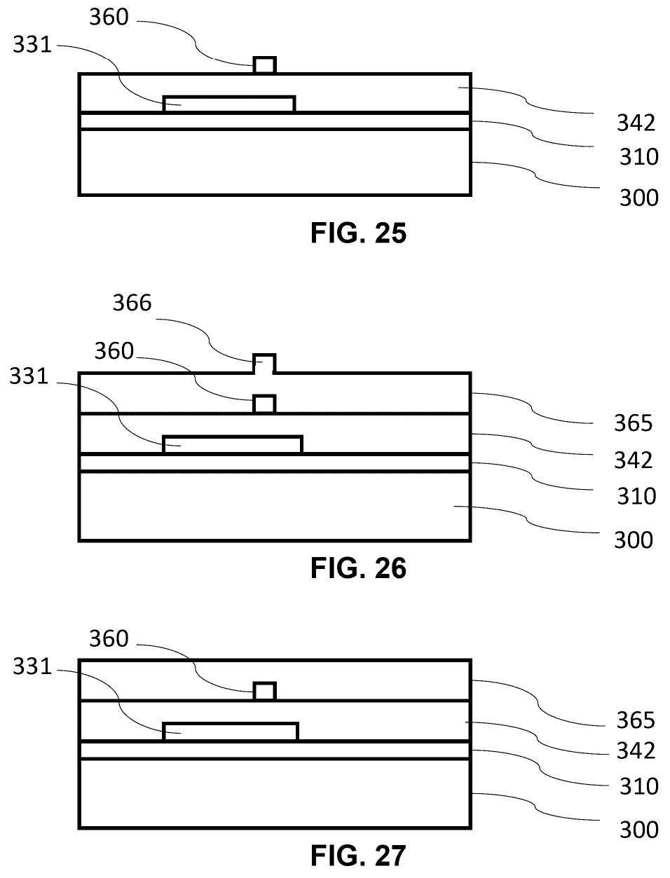

At block 445, the resist 355 may be exposed and developed. The nitride layer 350 may then be etched using reactive ion etching (RIE) or another etch technique to leave behind the patterned nitride 360, as shown in FIG. 25.

At block 450, an oxide layer 365 may be deposited using, for example, PECVD, LTO, or another physical or chemical deposition technique and annealed (for example, and without limitation, at 1000° C. for three hours) to densify the film 365. The deposition will leave a bump 366 in the oxide layer over the silicon nitride 360, as shown in FIG. 26, that may be planarized in a subsequent step.

At block 455, the bump 366 may be polished using, for example, chemical mechanical polishing (CMP), leaving a smooth, planar film 365, as shown in FIG. 27.

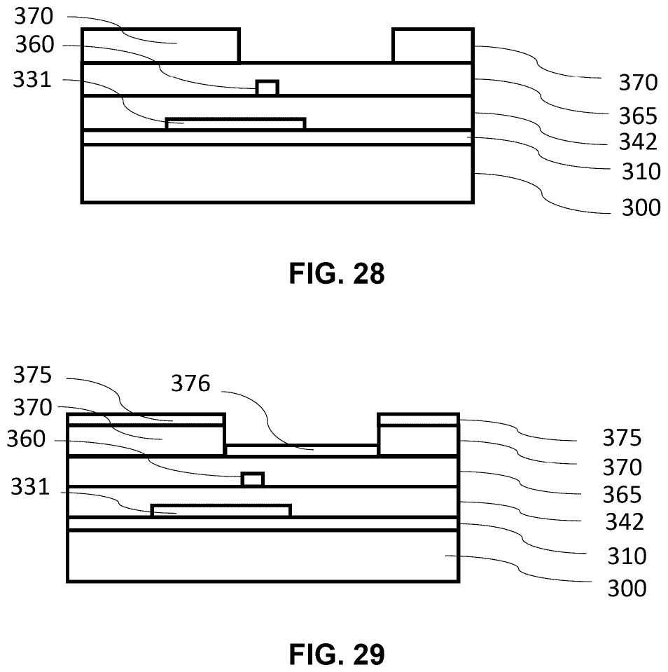

At block 460, a resist layer 370 may be spun, exposed, and developed, as shown in FIG. 28, which may be used as a sacrificial liftoff layer. This layer may be exposed in either an optical lithography or ebeam lithography system, for example.

At block 465, a chrome/platinum layer 375, 376 may be deposited, as shown in FIG. 29, using electron beam evaporation or physical sputtering.

At block 470, the sacrificial resist layer 370 may be removed along with the chrome/platinum layer 375 on top of the sacrificial layer 370, as shown in FIG. 30, by soaking in solvent, leaving only the chrome/platinum layer 376 directly on top of the oxide 365.

At block 475, a layer of resist 380 may be spun, exposed, and developed to act as an etch mask to etch a via 382 down to the platinum layer 331, as shown in FIG. 31.

At block 480 the oxide layer 365 may be etched down to the platinum layer 331 and the resist mask 380 may be removed in solvent, resulting in the device shown in FIG. 14

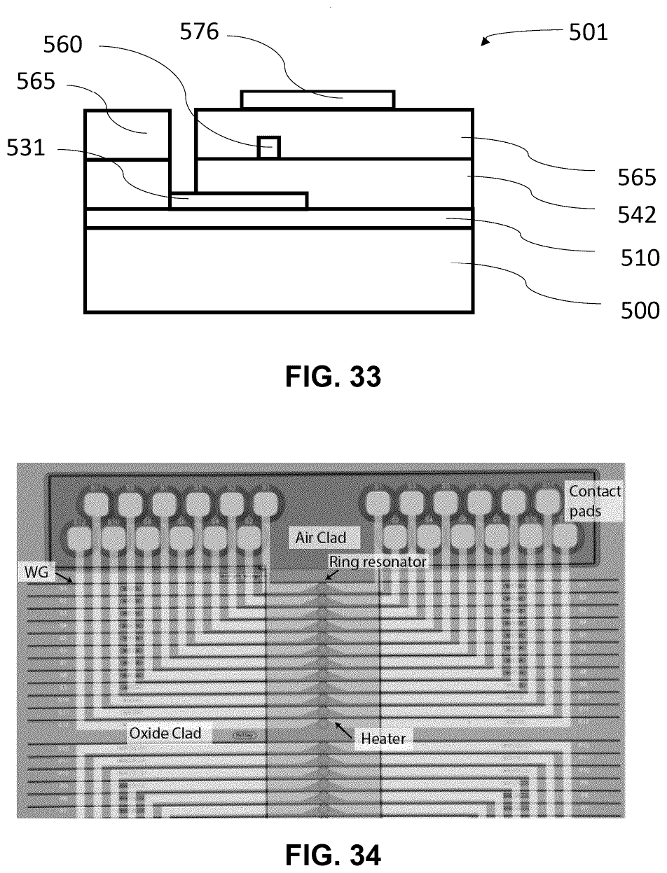

Referring now to FIG. 33, an exemplary stress-optic phase shifter 501 is shown. The phase shifter 501 includes a substrate 500, an insulating layer 510, a buried electrode 531, lower cladding 542, a waveguide layer 560, upper cladding layer 565, and a top electrode 576.

In this exemplary embodiment, an electric field is generated between the buried electrode layer 531 and the top electrode layer 576. This vertically-oriented field provides maximal effect for a waveguide layer 560 whose piezoelectric coefficients are maximal for a vertically-oriented electric field (z-axis direction shown in the image). The amplitude of the z-oriented field, for a given voltage, is larger using a buried electrode than it would be for side electrodes. The larger stress induced through the piezoelectric effect maps onto a change in refractive index.

Referring now to FIG. 34, shown is an optical microscope image of a fabricated chip consisting of WG-coupled microring resonators with the underlying buried heaters. In this chip, the microring resonators are air-clad (central portion of the chip), while the border of the chip has a top SiO₂ cladding, which is often useful for coupling light on and off the chip. More importantly, the metal traces running between the contact pads (where current is applied) and the buried heaters can be freely routed underneath the waveguides without problem. In contrast, the existing approach for air-clad devices, where the heaters are placed to the side of the relevant devices, places extreme restrictions on routing of the metal traces, as they cannot cross the waveguides without introducing loss or requiring additional fabrication steps to ‘jump over’ the waveguides (so-called crossovers).

The processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware, or a combination thereof.

Many other variations than those described herein will be apparent from this disclosure. For example, depending on the embodiment, certain acts, events, or functions of any of the processes described herein can be performed in a different sequence, can be added, merged, or left out altogether. Moreover, in certain embodiments, acts or events can be performed concurrently. In addition, different tasks or processes can be performed by different machines and/or computing systems that can function together.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix(s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. An optical phase shifter comprises:
a substrate;
an insulating layer adjacent the substrate;
a waveguide layer;
a cladding layer adjacent the waveguide layer; and
a buried electrode separated from the substrate by the insulating layer and from the waveguide layer by the cladding layer.

2. The optical phase shifter of claim 1, wherein the buried electrode is a metallic resistive heater element.

3. The optical phase shifter of claim 2, wherein the metallic resistive heater element is a thin metal or combination of metals.

4. The optical phase shifter of claim 1, wherein the buried electrode is configured to change temperature via electrical current and changes refractive indices of the cladding layer and the waveguide layer.

5. The optical phase shifter of claim 1, further comprising an upper cladding layer separating the waveguide layer from a top electrode.

6. A method of making an optical phase-shifter comprising the steps of:
depositing an oxide layer above a metal heater layer using a low temperature plasma;
polishing the oxide layer;
growing a waveguide layer; and
after depositing, polishing, and growing, performing high-temperature annealing above 1000° C.

7. A method of making a thermo-optic phase shifter comprises:
adding an insulating layer of thermal oxide on a silicon substrate;
spinning the substrate and insulating layer and exposing it to develop a first resist layer thereon;
depositing a chrome/platinum layer;
removing the first resist layer along with the chrome/platinum layer;
depositing a film oxide layer and annealing to densify the film oxide layer;
polishing a surface of the film oxide layer, leaving a smooth planar film;
depositing a layer of stoichiometric silicon nitride on the smooth planar film;
adding a second resist layer to act as an etch mask;
exposing and developing the second resist layer;
etching the nitride layer to leave behind patterned nitride;
adding a third resist layer;
exposing and developing the third resist layer so as to result in openings to the oxide layer; and
etching the oxide down to the platinum layer and removing a remainder of the resist layers.

8. A method of making an electro-optic or stress-optic phase shifter comprises:
adding an insulating layer of thermal oxide on a silicon substrate; al deposition techniques.
spinning the substrate and insulating layer and exposing it to develop a first resist layer thereon;
depositing a first chrome/platinum layer;
removing the first resist layer along with the first chrome/platinum layer;
depositing a first film oxide layer and annealing to densify the first film oxide layer;
polishing a surface of the first film oxide layer, leaving a smooth planar film;
depositing a layer of waveguide material on the smooth planar film;
adding a second resist layer to act as an etch mask;
exposing and developing the second resist layer;
etching the waveguide layer to leave behind a patterned waveguide;
depositing a second oxide layer and annealing to densify the second oxide layer;
polishing a surface of the second oxide layer, leaving a smooth planar film;
adding a third resist layer;
exposing and developing the third resist layer;
depositing a second chrome/platinum layer removing the third resist layer along with the second chrome/platinum layer, leaving only portions of the second chrome/platinum layer directly on top of the second oxide layer;
adding a fourth resist layer;
exposing and developing the fourth resist layer; and
etching the second oxide layer down to the first chrome/platinum layer.

9. The method of claim 8, wherein the patterned waveguide layer is an electro-optic waveguide.

10. The method of claim 8, wherein the patterned waveguide layer is a piezoelectric waveguide.
